(19) United States
(12) Patent Application Publication
(10) Pub. No.: US 2004/0205569 A1
(43) Pub. Date: Oct. 14, 2004

(54) Method and system to manage outdated web page links in a computing system

(76) Inventors: Jon S. McCarty, San Jose, CA (US); Mark A. Thompson, San Jose, CA (US); Lawrence M. Blair, Palo Alto, CA (US); Manisha A. Jain, Palo Alto, CA (US)

Correspondence Address: Sawyer Law Group LLP, P. O. Box 51418, Palo Alto, CA, 94303, US

(21) Appl. No.: 10/072,854

(22) Filed: Feb. 6, 2002

(51) Int. Cl. G06F 15/00

(52) U.S. Cl. 715/513; 715/501.1

(57) ABSTRACT

Systems and methods to manage outdated and stale URLs in a computing system are presented. The systems and methods obey the intent of a user navigating a dynamic Web site from non-current Web pages while avoiding state-changing side effects. That is, in responding to a link on previously viewed Web pages, the system performs a navigational operation associated with the link, and ignores and does not perform complementary, state-changing, operations that no longer apply due to the stale Web page's out-of-date state.

### TECHNICAL FIELD

The present invention relates to computing networks and the Internet, and, more particularly, to methods to improve navigation of Web sites on the Internet.

### BACKGROUND

To access services on the World Wide Web (WWW; Web) and the Internet, individuals utilize applications known as Web browsers. Microsoft Internet Explorer and Netscape Navigator are two common example of commercially available Web browsers. Users can visit a Web page by entering a Universal Resource Locator (URL) into a field on the browser or by clicking on or otherwise selecting a link or URL to the Web page. Internet Web browsers generally allow individuals to use a browser history mechanism or a back button to give the individuals access to Web pages that they have previously visited.

All dynamic Web applications that respond to user interaction have to contend with users selecting links from potentially previously generated Web pages. This can be problematic due to several potential conditions and disadvantages. First, the information on a previously generated Web page may be out of date, and selecting a link may not be appropriate at the current up to date state. Second, the previously viewed Web page may have been one part of a sequence of operations, in which performing the individual part of the sequence is undesirable. For example, many e-commerce Web sites charge a user twice for a single order if the user uses their Web browser history and clicks again on the button that actually triggers a credit card charge. Third, the Web application run by a particular organization may not allow a user to select a stale, or outdated, link due to the particular logic of the proprietary application set up for the organization. For example, a student taking a test or questionnaire administered by a Web application may be allowed only one try at answering a question and should not be to change a submitted answer on an online test.

Existing dynamic Web applications attempt to solve the problem of dealing with a user's ability to view the user's own history of visited Web sites in a wide variety of ways, all of which have drawbacks and disadvantages. One solution attempts to prevent the user from utilizing any Web browser history or back button functions. Web sites frequently attempt this by opening a application in a separate window that does not include a back button. This is a poor solution because it restricts the capabilities of the user. Furthermore, this technique is easily circumvented by the user, who can utilize different mouse buttons or keyboard combinations to navigate to where the user wants to go. This can lead to undesired results and unintended side effects.

A second solution is performing the side effects of a link again. Many Web applications simply perform whatever operation the link or form would have caused when a user selects the link or form for a second time. On an e-commerce Web site, this commonly results in multiple credit-card orders being charged to the user. On a testing site, this could result in a user changing the answer to a question that the user has already answered, even though this might be contrary wishes of the Web site administering the test and to the desired response to the question. Merely performing the link's side effects again is a poor solution because it causes undesirable effects on the part of the user, on the part of the Web application, or both.

Another solution is to generate an error page if a stale link is selected by a user. Many Web applications detect links from non-current pages, but simply disrespect the intent of user entirely and generate error pages. These applications mark Web pages as expired or so that they cannot be cached in memory, and include some way of determining whether a link to a Web page is current or stale when the link is selected. In this way, when a user selects a link that the Web application determines is stale, the Web application responds to the user with an error page. In addition to being frustrating and counterproductive for the user, this solution does not respect the intent of the user when the user selects a link determined by the Web application to be stale.

Notwithstanding these problems and challenges, it is desirable to allow a user to utilize their Web browser's history and back button features. It is also desirable to, to the extent of the system's ability, respect the intent of the user when the user clicks on a stale or otherwise troublesome link. Accordingly, it would be desirable to provide an alternative navigational scheme that does not suffer from the above-described drawbacks and weaknesses.

### SUMMARY

The presently preferred embodiments described herein include systems and methods for obeying the intent of a user navigating a dynamic Web site from non-current Web pages while avoiding state-changing side effects.

A method of managing outdated URLs in a computing system is provided according to one aspect of the invention. According to the method, a state stamp flag included in a URL is examined. If the state stamp flag indicates that the URL is fresh, then both a complementary operation and a navigational operation are performed. Otherwise, only the navigational operation is performed.

A server in a computing system to manage outdated URLs is provided according to another aspect of the invention. The server includes an interface, a server page, and a session management engine. The interface receives a URL. The URL includes a state stamp flag and a URL state stamp. The server page is in communication with the interface and examines the state stamp flag. If the state stamp flag indicates that the URL is fresh, then the server page executes the URL by performing both a complementary operation and a navigational operation. If the state stamp flag indicates that the URL is stale, then the server page executes the URL by performing only the navigational operation. The session management engine is coupled to the interface and is in communication with the server page. The session management engine is configured to update a stored state stamp and to compare the URL state stamp with the stored state stamp.

A method of managing outdated links in a computing system is provided according to a further aspect of the invention. According to the method, a user status of a user and a Web application status of a Web application are examined. A state stamp is generated based on the user status and the Web application status. The state stamp is updated each time that either the user status changes or the Web application status changes. A Web page that displays several URLs is generated. The updated state stamp is incorporated into each URL of the plurality of URLs. A first URL to a second Web page is received. The first URL is selected by the user and incorporates a first state stamp. The first URL stores instructions to perform a navigational operation and an complementary operation. The first state stamp is compared with a most current value of the updated state stamp. If the first state stamp matches the most current value of the update state stamp, then the navigational and the complementary operation are performed. If the updated state stamp is more recent than the first state stamp, then the navigational operation is performed and the complementary operation is not performed.

A method of managing outdated links in a computing system is provided according to another aspect of the invention. According to the method, a state stamp is updated based on state changes from a user and from a Web application. The updated state stamp is incorporated into a link. The updated state stamp is a most current value of the state stamp at the time that the updated state stamp is incorporated into the link. A received link stores instructions to perform a navigational operation and a complementary operation. Prior to executing the received link, a first state stamp in the received link is compared with a latest value of the updated state stamp. If the latest value is more recent than the first state stamp, then the navigational operation is performed and the complementary operation is not performed. Otherwise, both the navigational operation and the complementary operation are performed.

A method of managing outdated links in a computing system is provided according to a further aspect of the invention. According to the method, a link is received from a user. The link stores instructions to perform a navigational operation and an complementary operation. If a state stamp value stored within the link is less recent than a system state stamp value, then the navigational operation is performed and the complementary operation is not performed. Otherwise, both the navigational operation and the complementary operation are performed.

### BRIEF DESCRIPTION OF THE DRAWINGS

The foregoing and other features, aspects, and advantages will become more apparent from the following detailed description when read in conjunction with the following drawings, wherein:

FIG. 1 is a diagram illustrating the interaction of a user with an exemplary Web application server according to a presently preferred embodiment;

FIG. 2 is a flow diagram illustrating a first portion of an exemplary method of managing outdated links in a computing system according to the exemplary computing system of FIG. 1;

FIG. 3 is a flow diagram illustrating a second portion of an exemplary method of managing outdated links in a computing system according to the exemplary computing system of FIG. 1;

FIG. 4 is a diagram illustrating an exemplary screenshot sequence that shows Web pages displayed to a user in an online testing example in accordance with FIGS. 1-3; and

FIG. 5 is a diagram illustrating an exemplary screenshot sequence that shows Web pages displayed to a user in an online transaction example in accordance with FIGS. 1-3.

### DETAILED DESCRIPTION OF THE PRESENTLY PREFERRED EMBODIMENTS

The present invention will now be described in detail with reference to the accompanying drawings, which are provided as illustrative examples of preferred embodiments of the present invention.

The presently preferred embodiments described herein include systems and methods for obeying the intent of a user navigating a dynamic Web site from non-current Web pages while avoiding state-changing side effects. That is, in responding to a link on previously viewed Web pages, the system performs a navigational operation associated with the link, and ignores and does not perform complementary, state-changing, operations that no longer apply due to the stale Web page's out-of-date state.

Dynamic web applications that allow user input must contend with users selecting links from potentially previously generated pages. The systems and methods described herein support the user in a way superior to existing solutions. The user is permitted to utilize their browser history by, for example, bookmarking a Web page for later reference, or clicking a back button to return to an previously viewed Web page. When the URL links stored on the bookmarked Web page or previously viewed Web page are selected, the system respects the intent of the user is respected by navigating to the intended Web page, while regenerating the intended Web page based on the user's current up-to-date state. Undesirable side-effects of stale URL links are avoided by explicitly not performing the stateful, or complementary, effect of the stale URL link.

In a presently preferred embodiment, a Web application decorates each URL link on a Web page with a state-stamp. Preferably, each time that the Web application server determines that an action or operation has occurred that changes the user's or the application's state, a new state-stamp is generated and included into each URL link that appears on generated web pages.

In a presently preferred embodiment, when a user selects a URL, a session manager on the Web application server can examine the state-stamp and determine if the link came from the current, up-to-date state, or whether it came from a page based on a previous, not up-to-date, state. Accordingly, application files or server pages on the Web application server can execute functions based on whether the URL link is fresh or stale.

If the Web application server receives a URL request with the most recent state-stamp, the request is handled at face value. However, a URL request with a stale time-stamp is handled in a special manner. This stale URL link is examined for two different effects. First, the navigational effect of the URL link is determined and respected. Whatever Web page the user would have arrived at if the URL link had been processed while the link was in the current state is re-generated by the Web application server and is presented to the user. This Web page will be generated with the current, actual state of the system, and will not be based on the state of the system at the time the original, now stale URL link, was created and sent out as part of a Web page. Second, the stateful, or complementary, effect of the stale URL link is ignored by the application files or server pages. Whatever other complementary side effects such a link would have incurred beyond the navigational effect, such as submitting a credit-card order, changing information in a form, or answering a question on an on-line administered test-are not processed.

The presently preferred systems and methods described herein can be applied to any server driven Web application that changes its content based on the user's interactions with the hosted Web site. Certain Web applications particularly benefit: applications that include sequences of pages that perform a single overall task, such as placing a credit-card order, for example; and applications that have non-trivial internal business logic and navigational control, such as a game or a testing product that presents problems or questions in sequence with rules that govern a user's ability to go back and revisit questions.

The presently preferred systems and methods described herein are also used advantageously with Web sites that allow more free form browsing, such as on line catalogs. In certain embodiments, the system selectively respects the side effects of links on stale pages, instead of categorically ignoring them. This is useful for Web sites that include both links that are intended to be respected, and links that are not intended to be respected, on a single page. For example, an e-commerce site could be structured to allow a user to add an item to their shopping basket from a stale Web page, while not allowing the user to perform ordering for items that have been recently ordered.

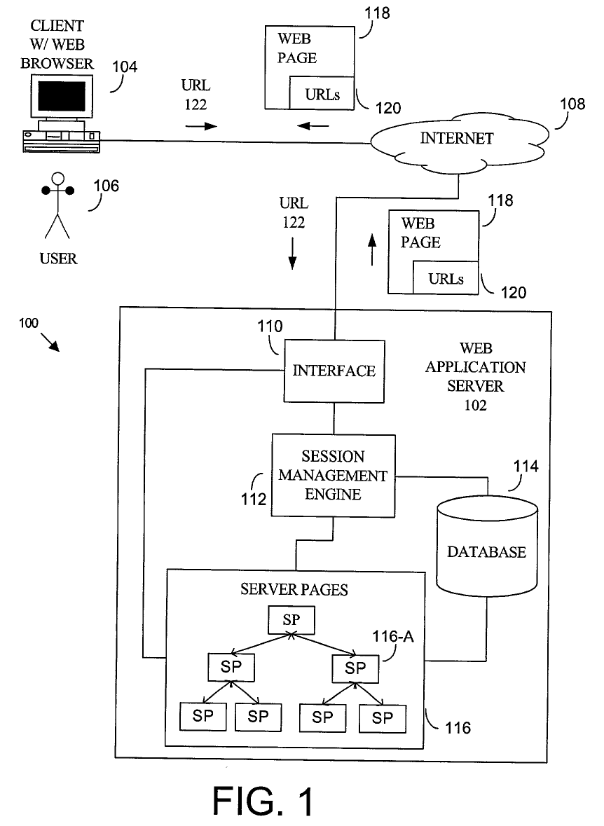

Referring now to FIG. 1, it is a diagram illustrating the interaction of a user 106 with an exemplary Web application server (WAS) 102 in a computing system 100 according to a presently preferred embodiment. The user 106 operates a Web browser on a client 104 computing device and communicates with the WAS 102 via the Internet 108. The WAS 102 includes an interface 110, a session management engine (SME) 112, a memory 114 such as a database 114, and application files or server pages (SPs) 116. The interface 110 communicates directly with the SME 112 and the SPs 116. The SME 112 communicates directly with the interface 110, the database 114 and the SPs 116. The database 114 can be accessed directly by the SPs 116 as well as the SME 112. The WAS 102 generates HTML documents that form Web pages 118 containing URLs 120 and forwards the HTML documents to, for example, the client 104, according to a protocol such as the HyperText Transfer Protocol (HTTP), as is well known in the art. The user 106 views the Web pages 118 on the Web browser running on the client 104 and clicks on URL links 120 on the Web pages 118 that generate and send URL requests 122 to the WAS 102.

Of course, it should be understood that the networked configuration, connections, and communication links shown in FIG. 1 are merely intended to be exemplary, and that other configurations, connections, and links are possible and may be used as suitable. For example, although the database 114 is shown in FIG. 1, it should be understood that generally any memory 114 or data storage medium may be used as suitable according to aspects of the present invention. Similarly, any number of user 116 and client 104 computing devices may communicate with the WAS 102 as suitable. The communication links may include intermediate networks or network devices, for example the user 116 at the client 104 computing devices may communicate with the WAS 102 via the Internet 110 and, for example, a local telephone exchange or a wireless access point. The functions of the WAS 102 may be partitioned between one or more servers as suitable. For example, a session management engine with associated functions may be located in one server while the server pages with associated functions or the database may be located in one or more other servers.

The SPs 116 are application files, for example, files with ASP (Active server page), JSP (Java server page), JHTML ( Java HTML), and SHTML (Server side include HTML) extensions. The workflow between two SPs 116 is illustrated by the arrows between the SPs 116. The WAS 102 receives URLs 122 that reference a directory of SPs 116 on the WAS 102 so that particular SPs 116 are called and perform functions. An example of a function that an SP 116 such as SP 116-A might perform is to bill the credit card of a user having an authenticated user session. The function might be structured as follows:

Function

BILL CREDIT CARD {CC#} [Complementary Operation]

[Navigational Operation]

End Function

where CC# is a variable that keys into the database 114 to obtain the credit card information for the user. A web page would then be displayed to the user (a navigational operation), indicating, for example, that the credit card had been charged (a complementary operation) and presenting the invoice detail.

In accordance with the presently preferred embodiments, an exemplary function performed by the SP 116-A could be structured as follows

Function

IF (URL State Stamp Flag=1) THEN [Condition]

BILL CREDIT CARD {CC#} [Complementary Operation]

[Navigational Operation]

End Function

where CC# is a variable that keys into the database 114 to obtain the credit card information for the user 106. In addition to storing user information, the database 114 preferably stores the most recent value of a state stamp variable. Each URL preferably includes a URL state stamp and a URL state stamp flag. The WAS 102 compares the URL state stamp with the stored state stamp in the database 114. The result of this comparison is to either leave the URL state stamp flag as valid, the flag thus indicating to the particular SP 116 that the URL is fresh, or to clear the URL state stamp flag, the flag thus indicating to the particular SP 116 that the URL is stale. As can be seen from the exemplary SP 116-A function above, if the URL state stamp flag is clear, then the navigational operation is performed by the SP 116-A and the complementary operation is not performed. If the URL state stamp flag is set, then both the complementary and the navigational operations are performed.

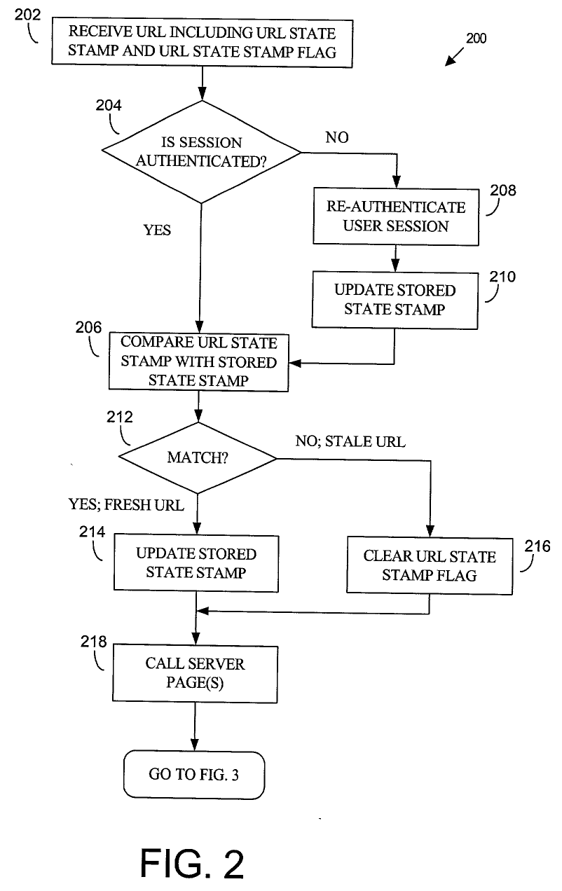

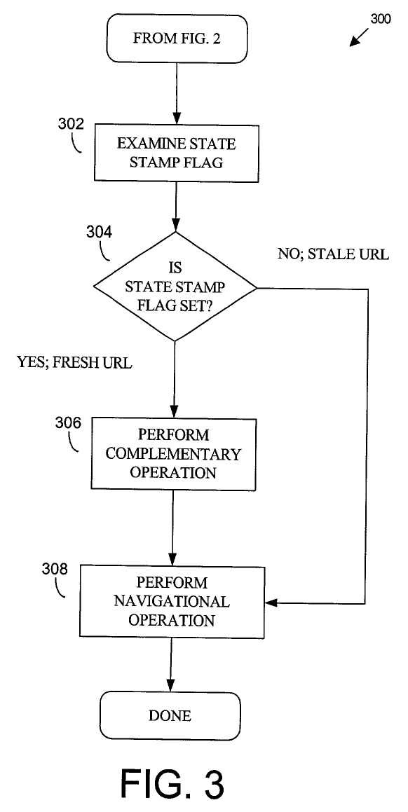

FIG. 2 is a flow diagram illustrating a first portion 200 of an exemplary method of managing outdated links in a computing system according to the exemplary computing system 100 of FIG. 1. Preferably, the steps of the flow diagram are performed by the interface 110 and the SME 112 of FIG. 1. FIG. 3 is a flow diagram illustrating a second portion 300 of an exemplary method of managing outdated links in a computing system according to the exemplary computing system 100 of FIG. 1. Preferably, the steps of the flow diagram are performed by the SPs 116 of FIG. 1.

Preferably, the user 106 is assigned a userid or a username and is preferably allowed to select a password to use to access the system 100. If the user has been registered with the WAS 102 of the system 100, then the WAS 102 stores user 106 information in the database 114, such as, for example, a shipping address, a credit card number, or prior test results.

The WAS 102, using the SPs 116, generates HTML documents that form Web pages 118 containing URLs 120 and forwards the HTML documents to the client 104. As described above, each SP 116 is a separate application file that includes code to perform, for example, one or more complementary operations and one or more navigational operations. Each URL 120 preferably includes a URL state stamp flag as well as a URL state stamp. Preferably, all of the URLs 120 that decorate the Web pages 118 created by the WAS 102 and the SPs 116 and sent by the WAS 102 include URL state stamp flags that are set as active current fresh to indicate a fresh URL 120.

The user 106 views the Web pages 118 on the Web browser running on the client 104 and clicks on URL links 120 on the Web pages 118 that generate and send URL requests 122 to the WAS 102.

According to the exemplary method portion 200 shown in FIG. 2, at step 202 of FIG. 2, the interface 110 of the WAS 102 receives a URL request 122, including the URL state stamp and the URL state stamp flag, from the client 104. Preferably, the URL 122 further includes a user session identifier as well. The URL 122 is forwarded by the WAS 102 to the SME 112, which first determines whether the user session for the URL 122 is authenticated at step 204. If the user session is not authenticated, processing continues to step 208 and the SME 112 reauthenticates the user session. Preferably, the user 106 is prompted for a userid and password or other identification. The process of reauthentication creates a new user session with a new user session ID. Preferably, the stored state stamp stored within the database 114 is based on the session ID, so that creating a new user session ID in turn updates the stored state stamp, at step 210. The SME 112 writes the stored state stamp into the database 114 over the previously stored value. Processing continues to step 206, where the SME 112 compares the URL state stamp within the URL 122 with the updated stored state stamp stored in the database 114. At this point, the URL state stamp is stale, since the stored state stamp in the database 114 was just updated at step 210 as a result of reauthentication in step 208.

If the user session is authenticated at step 204, then at steps 206 and 212 the SME 112 compares the URL state stamp within the URL 122 with the stored state stamp stored in the database 114 and determines whether there is a match. If the URL state stamp is stale, that is, if the URL state stamp does not match the stored state stamp, then at step 216 the SME 112 clears the URL state stamp flag so that the URL state stamp flag indicates a stale URL 122 and processing continues to step 218.

If the URL state stamp is fresh, that is, the URL state stamp flag is set active current fresh, then the URL 122 is fresh and the URL state stamp flag is not changed or cleared. Preferably, processing continues to step 214, where the SME 112 updates the stored state stamp based on the receipt of the fresh URL 122 from the authenticated, or from the reauthenticated, user session. The SME 112 writes the stored state stamp into the database 114 over the previously stored value.

The URL 122 indicates to the WAS 102 which SP or SPs 116 to execute. At step 218 the SPs 116 are called and processing of the authenticated or reauthenticated URL 122 is transferred from the SME 112 to the SPs 116.

Processing continues to FIG. 3, where an SP 116-A called by the URL 122 follows the following general thread of execution. At steps 302 and 304, the SP 116-A examines the URL state stamp flag within the URL 122 and determines whether the URL state stamp flag is set active current fresh. If the URL state stamp is set, then the URL 122 is fresh and the SP 116-A performs a complementary operation at step 306 and a navigational operation at step 308 and processing of the URL 122 by the SP 116-A terminates. If the URL state stamp is clear, then the URL 122 is stale, and the SP 116-A bypasses step 306 and processing continues to step 308, where the SP 116-A performs a navigational operation at step 308 and processing of the URL 122 by the SP 116-A terminates.

In an online testing example, the complementary operation of step 306 could include, for example, crediting an answer to a question on an online test and calculating a score on the test. In an online transaction example, the complementary operation of step 306 could include billing a credit card and preparing an invoice.

The navigational operation of step 308 includes sending a Web page 118 (or set of HTML files) to a Web browser so that the Web page 118 is displayed to the user 106 at the client 104 computing device. The navigational operation could be, for example, the result of the user 106 accessing a bookmarked Web page 118, hitting a back button on the browser to reach a previously viewed Web page 118, or by clicking on a button that leads to the Web page 118 being displayed.

It should be understood that any suitable number of complementary operations may be performed in conjunction with step 306. Similarly, any suitable number of navigational operations may be performed in conjunction with step 308. It should be further understood that the individual SPs 116 may be programmed to perform other complementary actions or navigational action depending on the value of the state stamp flag. In other words, according to an example SP 116, for one value of the state stamp flag, a complementary operation A and a navigational operation B are performed, for another value of the state stamp flag, a complementary operation C and a navigational operation C are performed.

In a presently preferred embodiment, the stored state stamp is a randomized, encrypted combination of a fundamental seed value, such as the user session ID, which is guaranteed to be unique across user sessions as well as across a user's history of sessions, and a series of monotonic numbers. Of course, the stored state stamp may be generated in any suitable fashion, although the stored state stamp preferably is unique across sessions.

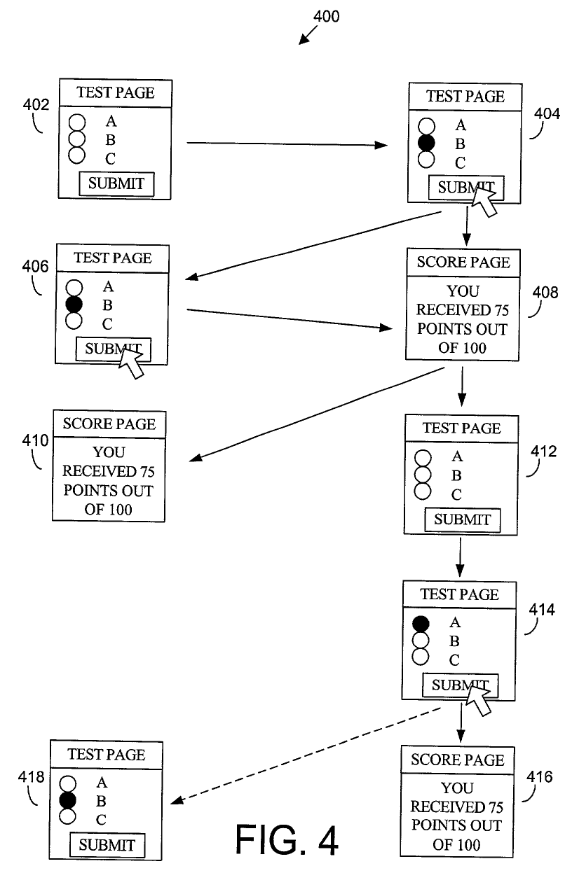

Referring now to FIG. 4, it is a diagram illustrating an exemplary screenshot sequence 400 that shows Web pages displayed to a user 106 in an online testing example in accordance with FIGS. 1-3. At test page/screenshot 402, the user 106 is asked the last question on the online test. At the test page 404, the user 106 selects answer choice B and clicks the submit button. This sends a URL request 122, in this case a fresh URL 122, to the WAS 102 and causes an SP 116-A to perform two complementary operations and a navigational operation. For the complementary operations, the SP 116-A credits the user's 106 answer choice B and calculates the score of the user 106. For the navigational operation, the SP 116-A causes the score page 408 to be displayed to the user 106.

If instead the user 106 does not patiently wait for the score page 408 to be displayed and, after some time, the user 106 clicks the submit button again at test page 406, or if the user 106 changes the answer and clicks submit again at test page 406, then the resulting URL request 122 will not be processed until after the first URL request 122 has caused the stored state stamp to be updated. The resulting URL request 122 will thus be stale, the complementary operations of crediting the new answer or recalculating the score will not be performed, and the navigational operation will display the score page 408 to the user 106.

The user 106 bookmarks the score page 408 and later accesses the score page 408, which causes a stale URL request to be sent to the WAS 102. No complementary operations will be performed, that is, the score is not recalculated, but the navigational operation is performed and the score page 410 is displayed to the user 106.

From the score page 408, the user 106 clicks the browser back button to attempt to display the previous test page 404, for example. A test page 412 similar in appearance to the test page 402 and having a blank question is displayed. Seeing the blank question, the user 106 changes the answer and selects answer choice A, which is the correct answer, and clicks the submit button on the test page 414.

A stale URL request 122 is sent to the WAS 102 so that the complementary operations are not performed, i.e., the original answer choice of B is retained, the new answer choice of A is not credited, and the user's 106 score is not recalculated. The navigational operation is performed however, and a score page 416 showing the unchanged score is displayed to the user 106. Depending on the programming of the SPs 116, a different page such as a test page 418 could be displayed to the user 106 that shows the user's 106 actual credited answer choice of B.

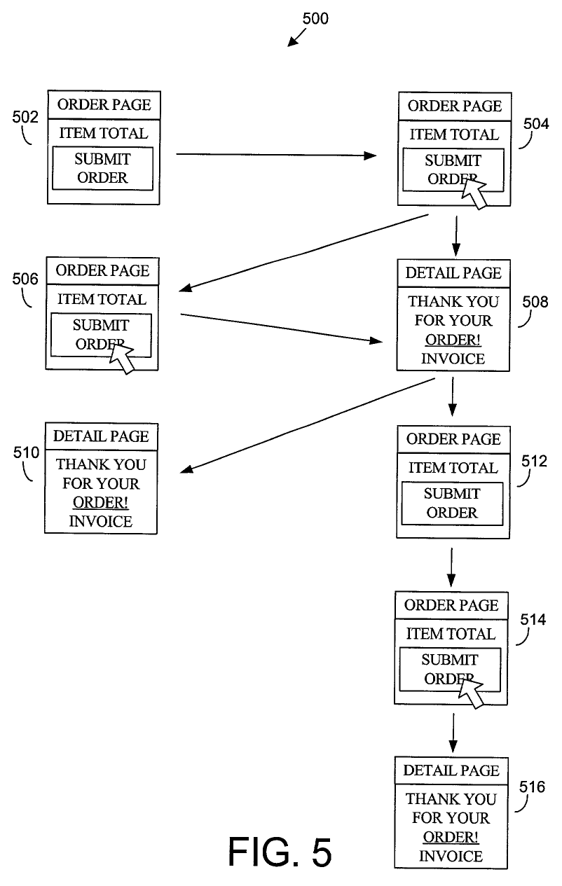

Referring now to FIG. 5, it is a diagram illustrating an exemplary screenshot sequence 500 that shows Web pages displayed to a user 106 in an online transaction example in 20 accordance with FIGS. 1-3. At order page/screenshot 502, the user 106 is shown an item total and asked to charge the user's 106 credit card by submitting the order. At the order page 504, the user 106 decides to order the items and clicks the submit order button. This sends a URL request 122, in this case a fresh URL 122, to the WAS 102 and causes an SP 116-A to perform two complementary operations and a navigational operation. For the complementary operations, the SP 116-A charges the user's 106 credit card and generates an invoice for the user 106. For the navigational operation, the SP 116-A causes the order confirmation/detail page 508 to be displayed to the user 106.

If instead the user 106 does not patiently wait for the detail page 508 to be displayed and, after some time, the user 106 clicks the submit order button again at order page 506, or if the user 106 changes the order and clicks submit order again at order page 506, then the resulting URL request 122 will not be processed until after the first URL request 122 has caused the stored state stamp to be updated. The resulting URL request 122 will thus be stale, the complementary operations of charging the credit card or regenerating the invoice will not be performed, the order will not be changed, and the navigational operation will display the detail page 508 to the user 106.

The user 106 bookmarks the detail page 508 and at some later time accesses the detail page 508, which causes a stale URL request to be sent to the WAS 102. No complementary operations will be performed, that is, the credit card is not charged and the invoice is not regenerated, but the navigational operation is performed and the detail page 510 is displayed to the user 106.

From the detail page 508, the user 106 clicks the browser back button to attempt to display the previous order page 504, for example. An order page 512 similar in appearance to the order pages 504, 502 and having the item total is displayed. The user 106 clicks the submit order button again, or changes the order and clicks submit order again, on the order page 514.

A stale URL request 122 is sent to the WAS 102 so that the complementary operations are not performed, i.e., the credit card is not charged and the invoice is not regenerated. The navigational operation is performed however, and a detail page 516 showing the unchanged invoice is displayed to the user 106.

Although in a presently preferred embodiment, certain functions are performed by the session management engine and the server pages, in other embodiments, the methods illustrated in FIGS. 2-3 are built into the Web application server as a standard service available to applications running on top of the Web application server. Similarly, the methods illustrated in FIGS. 2-3 can be incorporated to run in a single server page or application file, independent of the Web application server services or of session management.

The present invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method acts of the invention can be performed by a programmable processor executing a program of instructions to perform functions of the invention by operating on input data and generating output. The invention can be implemented advantageously in one or more computer programs that executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

Although the present invention has been particularly described with reference to the preferred embodiments, it should be readily apparent to those of ordinary skill in the art that changes and modifications in the form and details may be made without departing from the spirit and scope of the invention. It is intended that the appended claims include such changes and modifications.

What is claimed is:

1. A method of managing outdated URLs in a computing system, comprising:
examining a state stamp flag included in a URL; and
if the state stamp flag indicates that the URL is fresh, then
performing both a complementary operation and a navigational operation; otherwise,
performing only the navigational operation.

2. The method according to claim 1, further comprising:
receiving a URL, the URL including the state stamp flag, a URL state stamp and a session identifier that identifies a user session.

3. The method according to claim 2, further comprising:
determining whether the user session is authenticated.

4. The method according to claim 3, further comprising:
if the user session is not authenticated, then
re-authenticating the user session; and
updating a stored state stamp.

5. The method according to claim 4, further comprising:
determining whether the URL state stamp matches the stored state stamp.

6. The method according to claim 5, further comprising:
if the URL state stamp does not match the stored state stamp, then
adjusting the state stamp flag to indicate that the URL is stale;
executing the URL; and
performing the act of examining.

7. The method according to claim 6, further comprising:
if the URL state stamp matches the stored state stamp, then
updating a stored state stamp;
executing the URL; and
performing the act of examining.

8. The method according to claim 6, further comprising:
creating HTML files to send to a client to form a Web page at the client, the HTML files including a sent URL;
incorporating the stored state stamp and a sent state stamp flag into the sent URL;
adjusting the sent state stamp flag to indicate that the URL is fresh.

9. A server in a computing system to manage outdated URLs, the server comprising:
an interface to receive a URL, the URL including a state stamp flag and a URL state stamp;
a server page in communication with the interface to examine the state stamp flag; wherein if the state stamp flag indicates that the URL is fresh, then the server page executes the URL by performing both a complementary operation and a navigational operation; and wherein if the state stamp flag indicates that the URL is stale, then the server page executes the URL by performing only the navigational operation; and
a session management engine coupled to the interface and in communication with the server page, the session management engine configured to update a stored state stamp and to compare the URL state stamp with the stored state stamp.

10. The server according to claim 9, further comprising:
a database to store the stored state stamp, the database being coupled to the interface, the server page, and the session management engine.

11. The server according to claim 9, wherein the URL further includes a session identifier that identifies a user session.

12. The server according to claim 11, wherein the session management engine determines whether the user session is authenticated, and, if the user session is not authenticated, re-authenticates the user session and updates the stored state stamp.

13. The server according to claim 12, wherein if the session management engine compares the URL state stamp with the stored state stamp and the URL state stamp does not match the stored state stamp, then the session management engine adjust the state stamp flag to indicate that the URL is stale, otherwise the session management engine updates the stored state stamp.

14. A computing system to manage outdated URLs, the computing system in communication with the Internet, comprising:
means for examining a state stamp flag included in a URL, the URL having associated complementary operations and navigational operations;
means for selectively performing the complementary operations based on the state stamp flag, wherein if the state stamp flag indicates that the URL is fresh, then less than all of the complementary operations are performed; and
means for performing a navigational operation irrespective of the state stamp flag.

15. A method of managing outdated links in a computing system, comprising:
examining a user status of a user and a Web application status of a Web application;
generating a state stamp based on the user status and the Web application status;
updating the state stamp each time that the either the user status changes or the Web application status changes;
generating a Web page, the Web page displaying a plurality of URLs;
incorporating the updated state stamp into each URL of the plurality of URLs;
receiving a first URL to a second Web page, the first URL selected by the user and incorporating a first state stamp, the first URL storing instructions to perform a navigational operation and an complementary operation;
comparing the first state stamp with a most current value of the updated state stamp; and
if the first state stamp matches the most current value of the update state stamp, then performing the navigational and the complementary operation; and
if the updated state stamp is more recent than the first state stamp; then
performing the navigational operation; and
not performing the complementary operation.

16. A method of managing outdated links in a computing system, comprising:
updating a state stamp based on state changes from a user and from a Web application;
incorporating the updated state stamp into a link, the updated state stamp being a most current value of the state stamp at the time that the updated state stamp is incorporated into the link; and
prior to executing a received link, the received link storing instructions to perform a navigational operation and an complementary operation:
comparing a first state stamp in the received link with a latest value of the updated state stamp, wherein if the latest value is more recent than the first state stamp, then
performing the navigational operation and not performing the complementary operation,
otherwise,
performing both the navigational operation and the complementary operation.

17. A method of managing outdated links in a computing system, comprising:
receiving a link from a user, the link storing instructions to perform a navigational operation and an complementary operation;
if a state stamp value stored within the link is less recent than a system state stamp value, then
performing the navigational operation and not performing the complementary operation,
otherwise,
performing both the navigational operation and the complementary operation.
